(19) United States
(12) Patent Application Publication
(10) Pub. No.: US 2006/0020798 A1
(43) Pub. Date: Jan. 26, 2006

(54) Method of verifying network transactions

(75) Inventors: Cheng-Shing Lai, Taipei Hsien (TW); Xiao-Ming Du, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,192

(22) Filed: Jun. 23, 2004

(51) Int. Cl. H04L 9/00

(52) U.S. Cl. 713/170

(57) ABSTRACT

The present invention is to provide a method of verifying network transactions, which comprises the steps of issuing a first transaction request from a user end to a verifying server; randomly creating a dynamic password by the verifying server; sending the dynamic password back to the user end; issuing a second transaction request including the dynamic password and an input user signature to the verifying server; verifying the dynamic password and the user signature by the verifying server; and issuing a transaction permission to a Internet bank transaction system.

### FIELD OF THE INVENTION

The present invention relates to network transactions over the Internet, more particularly to a method of verifying network transactions, which enables a user end (such as a cellular phone having a handwriting capability or a computer having a tablet in cooperation with a cellular phone) to carry out network transactions over the Internet through a verifying server by sending a dynamic password in cooperation with a signature of a user to perform a dual verification and significantly increase the security of network transactions.

### BACKGROUND OF THE INVENTION

Nowadays, a variety of network products are constantly available due to the booming of network technology. Such products have now been widely used in our daily life and work. As a result, both data transfer rate and efficiency over a network are greatly increased. This in turn brings a lot of convenience to our daily life and work.

Recently, the number of installing wireless network (e.g., LAN (Local Area Network)) cards to personal computers is increased gradually. Any user of a personal computer installed with a wireless network card is thus able to retrieve information over a network by taking advantage of the progress of wireless LAN technology. The need for Internet bank and Internet payment is also increased significantly due to the wide applications of the Internet and the improvement of e-commerce. The electronic services provided by the banks are getting popular, wherein the ATM (automatic transaction machine) service has now been developed into telephone bank service, cellular phone bank service, and even Internet bank service. However, most wireless networks do not have any protections. Thus, the chance of letting a hacker to invade a wireless network is gradually increased. Once being invaded, the hacker may use broadband without authorization, access the Internet without paying any fee, and even invade the Web site of an enterprise to steal secret, spread viruses, and/or modify Web pages. Hence, it is very important to provide a secure, reliable, timely, and correct network transaction service by eliminating the above problem.

Conventionally, an SSL (secure socket layer) is implemented on a TCP (transmission control protocol) of a network transaction system. Since the data transfer unit in TCP is segment, a checksum is added into the data being transferred so that a recipient may check the authenticity of the received data. Currently, SSL is the most widely used data encryption technique and is also used to verify a network for preventing an unauthorized person from intercepting data transferred over a network. In implementation, an SSL data security proxy in the form of Web proxy is installed at a user end for providing a data encryption feature to a browser. Both the SSL data security proxy and the browser are installed in the same computer. The browser may issue a request to the SSL data security proxy prior to establishing a secure connection to a server at a remote end. In fact, the SSL data security proxy is responsible for establishing a connection to the remote server. After establishing the connection between the SSL data security proxy and the remote server, a data transfer between the browser and the remote server is done by the SSL data security proxy.

However, the electronic verification performed by the SSL data security proxy has a significant drawback of being poor in security due to two different passwords. Both the passwords are static ones so that they are susceptible of being decoded by guessing. Once being decoded, an unauthorized person may easily invade the network (i.e., it is highly insecure). Thus, it is desirable to provide a method of making a network transaction to be secure in order to overcome the above drawbacks of the prior art.

### SUMMARY OF THE INVENTION

An object of the present invention is to provide a method of verifying network transactions when a user end is about to perform a network transaction, which comprises the steps of issuing a first transaction request from a user end to a verifying server; randomly creating a dynamic password by the verifying server; sending the dynamic password back to the user end; issuing a second transaction request including the dynamic password and an input user signature to the verifying server; verifying the dynamic password and the user signature by the verifying server; and issuing a transaction permission to a Internet bank transaction system. By utilizing a dual verification of the signature and dynamic password of the present invention, the security of network transaction can be increased significantly. Moreover, the above drawbacks of the prior art can be overcome. These drawbacks are that the electronic verification performed by the SSL data security proxy is insecure and the passwords are susceptible of being decoded by guessing.

In one aspect of the present invention the user end is either a cellular phone having a handwriting capability or a computer having a tablet in cooperation with a cellular phone, thereby carrying out transactions including Internet bank, Internet insurance, Internet stock market, and Internet procurement. Further, the verifying server is a dedicated verifying server for verification and is able to verify a user transaction request so as to maintain integrity of a user application system and protect system resources.

The above and other objects, features and advantages of the present invention will become apparent from the following detailed description taken with the accompanying drawings.

### BRIEF DESCRIPTION OF THE DRAWINGS

FIG. 1 presents a structure applicable for a preferred embodiment of the invention;

FIG. 2 is a flow chart illustrating a network transaction process performed at a user end according to the preferred embodiment of the invention; and

FIG. 3 is a flow chart illustrating a process performed at a verifying server according to the preferred embodiment of the invention.

### DETAILED DESCRIPTION OF THE PREFERRED EMBODIMENTS

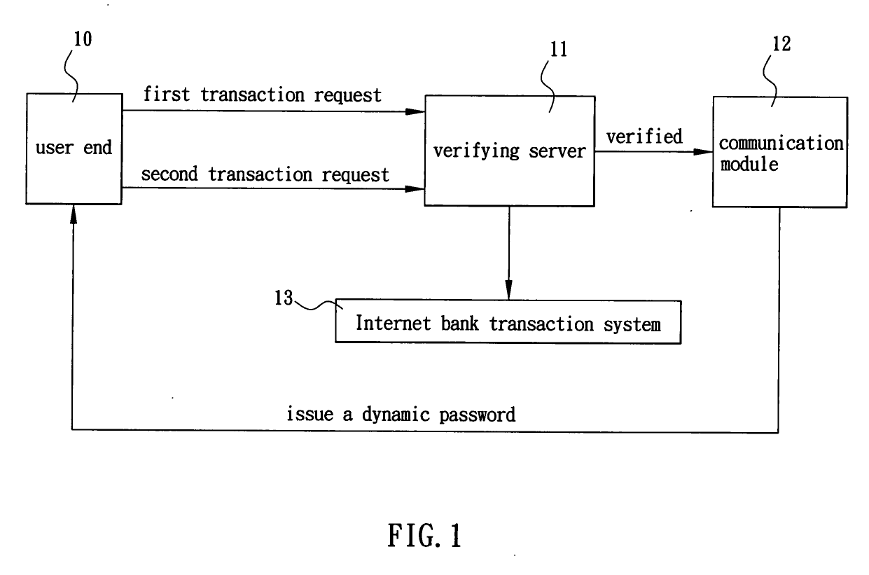

Referring to FIG. 1, there is shown a method of verifying network transactions in accordance with the invention. The method comprises the steps of issuing a first transaction request from a user end 10 to a verifying server 11 prior to permitting the user end 10 to perform a network transaction; randomly creating a dynamic password by a user database and a verification record of the verifying server 11; sending the dynamic password back to the user end 10 via a communication module 12; issuing a second transaction request including the dynamic password and the input user signature from the user end 10 to the verifying server 11; verifying the dynamic password and the user signature by the verifying server 11; and issuing a transaction permission to a Internet bank transaction system 13. By utilizing the invention, the security of network transactions can be significantly increased.

In a preferred embodiment of the invention, the user end 10 is a cellular phone having a handwriting feature or a computer having a tablet in cooperation with a cellular phone. The verifying server 11 is a dedicated verifying server 11 for verification and is able to verify a user transaction request so as to maintain integrity of a user application system and protect system resources. Further, the verifying server 11 has a user database and a verification record, which forms the random dynamic password verification of the invention and is able to verify a user's handwriting (e.g., signature).

In the embodiment, for carrying out the signature verification a user first leaves his/her signature in the Internet bank transaction system 13. The signature is defined by an X*Y matrix which is in turn stored in the verifying server 11. The user's signature is sent to the verifying server 11 for comparing with the stored signatures in the Internet bank transaction system 13 in terms of similarity when the user is performing a network transaction. A gradient is obtained by dividing x, y coordinate values of one end of a stroke of the signature by x, y coordinate values of the other end of the stroke. The gradient is again compared with the gradient of a corresponding stroke of a stored signature. It is determined that they are not similar if a difference between the gradient of any stroke of the handwriting and that of the stroke of a stored corresponding handwriting is larger than a predetermined value. Further, it is determined that they are not similar if a difference between the length of any stroke of the handwriting and that of the stroke of a stored corresponding handwriting is larger than another predetermined value. Alternatively, it is determined that they are similar if both the difference with respect to gradient and the difference with respect to length are smaller than the predetermined values.

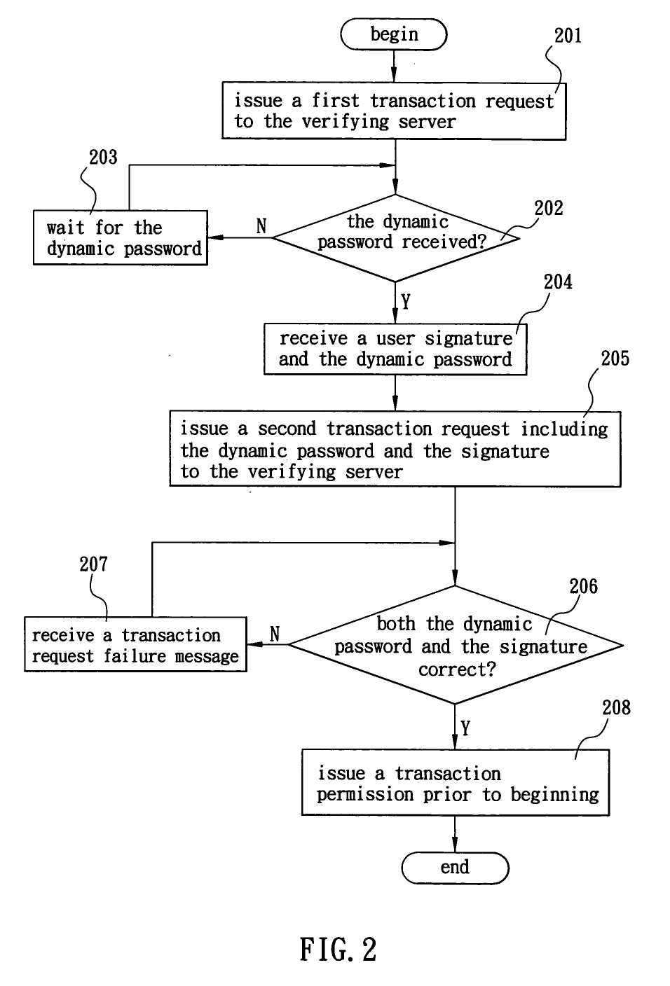

Referring to FIG. 2, there is shown a flow chart illustrating a network transaction process performed at the user end 10.

In step 201, issue a first transaction request from the user end 10 to the verifying server 11. The first transaction request automatically contains the number of a cellular phone if the user end 10 is a cellular phone having a handwriting feature. Alternatively, a network transaction platform will request the cellular phone to provide the number thereof if the user end 10 is a computer having a tablet so as to accept a dynamic password. Next, wait the verifying server 11 to randomly create a dynamic password by a user database and a verification record thereof.

In step 202, it is determined whether the user end 10 has received the dynamic password created by the verifying server 11 via the communication module 12. If yes, the process jumps to step 204. Otherwise, the process goes to step 203.

In step 203, wait for receiving the dynamic password prior to looping back to step 202.

In step 204, receive a user's signature. The signature is inputted by a handwriting screen of a cellular phone if the user end 10 is a cellular phone having a handwriting feature. Alternatively, the signature is inputted by a tablet of a computer if the user end 10 is a computer having a tablet.

In step 205, issue a second transaction request including the dynamic password and the signature to the verifying server 11.

In step 206, it is determined by the verifying server 11 whether both the dynamic password and the signature are correct or not. If yes, the process jumps to step 208. Otherwise (i.e., either one or both of the dynamic password and the signature being incorrect), the process jumps to step 207.

In step 207, receive a transaction request failure message from the communication module 12 prior to looping back to step 206.

In step 208, issue transaction permission to the Internet bank transaction system 13 via the verifying server 11.

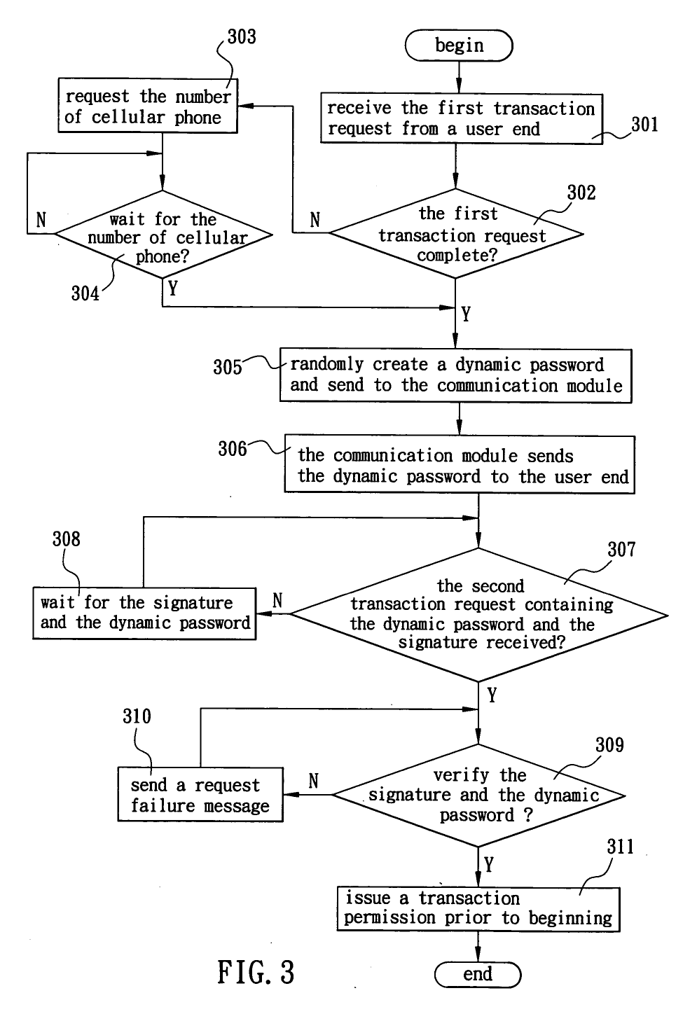

Referring to FIG. 3, there is shown a flow chart illustrating a process performed at the verifying server 11 in response to receiving the request for network transaction from the user end 10.

In step 301, receive the first transaction request from the user end 10.

In step 302, it is determined whether the first transaction request is complete (i.e., is the number of cellular phone available?) If yes, the process goes to step 303. Otherwise, the process jumps to step 305.

In step 303, request the user end 10 to provide the number of the cellular phone.

In step 304, the process goes to step 305 if the number of the cellular phone sent from the user end 10 has been received. Otherwise, the process loops back to itself for waiting the number of the cellular phone sent from the user end 10.

In step 305, randomly create a dynamic password by the user database and the verification record in which the dynamic password can be changed per day, per 12 hours, or per a predetermined number of hours depending on user settings. The dynamic password is then sent back to the communication module 12.

In step 306, after receiving the dynamic password sent from the verifying server 11, the communication module 12 sends the dynamic password to the user end 10 over a network.

In step 307, it is determined whether the second transaction request containing both the dynamic password and the signature sent from the user end 10 has been received. If yes, the process jumps to step 309. Otherwise, the process goes to step 308.

In step 308, wait for receiving the signature and the dynamic password prior to looping back to step 307.

In step 309, the signature of the user is compared with the stored signatures in the Internet bank transaction system 13 in terms of similarity and the dynamic password is compared with a previously sent dynamic password. If both are correct, the process jumps to step 311. Otherwise (i.e., either one or both of the comparisons being incorrect), the process goes to step 310.

In step 310, send a request failure message from the communication module 12 to the user end 10 prior to looping back to step 309.

In step 311, issue transaction permission to the Internet bank transaction system 13 prior to performing a network transaction.

In brief, by providing verifications of both the signature and dynamic password in accordance with a secure network transaction method of the invention, the security of network transaction can be increased significantly.

While the invention has been described by means of specific embodiments, numerous modifications and variations could be made thereto by those skilled in the art without departing from the scope and spirit of the invention set forth in the claims.

What is claimed is:

1. A method of verifying network transactions when a user end is about to perform a network transaction, comprising the steps of:
issuing a first transaction request from a user end to a verifying server;
randomly creating a dynamic password by a user database and a verification record of the verifying server;
sending the dynamic password back to the user end via a communication module;
issuing a second transaction request including the dynamic password and an input user signature from the user end to the verifying server;
verifying the dynamic password and the user signature by the verifying server; and
issuing a transaction permission to a Internet bank transaction system, thereby increasing security of the network transaction.

2. The method of claim 1, wherein the signature verification comprises the steps of:
leaving a user's signature in the Internet bank transaction system wherein the signature is defined by an X*Y matrix stored in the verifying server;
sending the user's signature to the verifying server over a network for comparing with stored signatures in the Internet bank transaction system in terms of similarity when the user is performing a network transaction;
obtaining a gradient by dividing x, y coordinate values of one end of a stroke of the signature by x, y coordinate values of the other end of the stroke; and
comparing the gradient with the gradient of a corresponding stroke of the stored signature.

3. The method of claim 2, wherein the network transaction executed by the user end causes the method to perform the steps of:
(a) issuing a first transaction request from the user end to the verifying server;
(b) randomly creating a dynamic password by the user database and the verification record of the verifying server;
(c) determining whether the dynamic password sent from the verifying server to the user end via the communication module has been received;
(d) if the determination in step (c) is positive, receiving the user's signature and the dynamic password;
(e) if the determination in step (c) is negative, waiting for receiving the dynamic password;
(f) issuing a second transaction request including the dynamic password and the signature to the verifying server;
(g) determining by the verifying server whether both the dynamic password and the signature are correct;
(h) if the determination in step (g) is positive, issuing a transaction permission to the Internet bank transaction system prior to beginning via the verifying server; and
(i) if the determination in step (g) is that either one of the dynamic password and the signature is incorrect or both the dynamic password and the signature are incorrect, receiving a transaction request failure message from the communication module.

4. The method of claim 2, wherein in response to receiving the request for network transaction from the user end the verifying server performs the steps of:
(i) receiving the first transaction request from the user end;
(ii) determining whether the first transaction request is complete by determining whether the number of a cellular phone is available;
(iii) if the determination in step (ii) is negative, requesting the user end to provide the number of the cellular phone;
(iv) if the determination in step (ii) is positive, randomly creating a dynamic password by the user database and the verification records and sending the dynamic password to the communication module;
(v) in response to receiving the dynamic password sent from the verifying server, causing the communication module to send the dynamic password to the user end over the network;
(vi) determining whether the second transaction request containing both the dynamic password and the signature sent from the user end has been received;
(vii) if the determination in step (vi) is positive, comparing the signature with the stored signatures in the Internet bank transaction system in terms of similarity and comparing the dynamic password with a previously sent dynamic password in terms of similarity;
(viii) if the determination in step (vi) is negative, waiting for receiving the signature and the dynamic password until both are received;
(ix) if the comparisons in step (vii) are positive, issuing a transaction permission to the Internet bank transaction system prior to beginning; and
(x) if the comparisons in step (vii) are that either one of the comparisons is incorrect or both the comparisons are incorrect, sending a request failure message from the communication module to the user end.

5. The method of claim 4, wherein the dynamic password is adapted to change depending on user settings.

6. The method of claim 1, wherein the user end is a cellular phone having a handwriting capability.

7. The method of claim 1, wherein the user end is a computer having a tablet in cooperation with a cellular phone.
